(19) United States
(12) Patent Application Publication
(10) Pub. No.: US 2005/0027880 A1
(43) Pub. Date: Feb. 3, 2005

(54) System and method for routing information in a nodal computer network

(76) Inventor: Darel Emmot, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/633,104

(22) Filed: Aug. 1, 2003

(51) Int. Cl. G06F 15/173

(52) U.S. Cl. 709/238; 709/223

(57) ABSTRACT

A system and method are provided for routing information in a multi-node network. In one embodiment of a multi-node network comprising a plurality of distributed switching nodes, a method is implemented in at least one of the plurality of nodes for routing information entering the node over a first channel to one of a plurality of other channels. The method comprises obtaining priority information for the information, ascertaining a remaining communication length for the information for each of the plurality of other channels, determining a current demand for each of the plurality of other channels; and routing the information entering at the first channel to one of the other channels based upon an evaluation that considers a combination of the obtained priority information, the ascertained communication length for each of the plurality of other channels, and the current demand for each of the plurality of other channels.

### BACKGROUND

1. Field of the Invention

The present invention relates to computer systems and, more particularly, to a system and method for routing information in a nodal computer network.

2. Discussion of the Related Art

In multi-node computer networks, there are a variety of known architectures and intercommunication methodologies. First generation multi-node systems utilized what is often referred to as store-and-forward interconnect networks. Store-and-forward interconnect networks transfer packets as single units from node to node along a path from source to destination. Each node waits to pass the head of a packet onto the next node until the last phit (physical transfer unit) of the packet has been received.

More recent multi-node systems utilize interconnect networks using what is known as wormhole routing. Wormhole routing interconnect networks route the head of the packet from a node before the tail of the packet is received by that node. The packet is divided into a number of smaller message packets called flow control units (flits), which may be one or more phits. A header flit contains routing information. The header flit is received by a processing element node and examined to ascertain its destination. The header flit is sent on to the next node indicated by the routing algorithm. The remaining flits follow behind the header flit in a train-like fashion. Flow control between nodes is accomplished on a flit-by-flit basis, rather than a packet-by-packet basis as in the store-and-forward interconnect networks. Thus, in wormhole routing, a packet may be partially transmitted across communication channel, and then blocked due to a shortage of buffer space in the receiving node.

Wormhole routing significantly reduces packet latency in lightly-loaded networks, because the time to transmit the packet onto a channel (phits per packet times clock period) is incurred only once per network transversal, rather than once per hop. Wormhole routing also significantly reduces network buffering requirements, as a node is not required to buffer an entire packet.

A problem with wormhole routing, however, is that when a header flit is blocked or stalled, the remaining flits stall behind the header. These remaining flits may possibly be across multiple channels and nodes in the network. Consequently, a blocked packet may prevent other packets from proceeding, even those that do not want to route through the node at which the header flit is blocked. This can cause significant network degradation, especially in the presence of non-uniform communication patterns.

Adaptive routing is another routing methodology and has been used to increase multi-node computer system performance. Adaptive routing interconnect networks dynamically route packets around congestion in the network. Thus, adaptive routing mechanisms dramatically increase network throughput and lower the sensitivity of the network to variations in communication patterns.

Adaptive routing algorithms are sometimes characterized as being either minimal or non-minimal. Minimal routing algorithms allow only shortest-distance routing paths between a source node and a destination node. Non-minimal algorithms allow packets to route along alternate paths that increase the total routing distance between the source and destination nodes. Thus, non-minimal algorithms permit adaptive routing in situations where minimal algorithms are constrained to a single path. In this way, non-minimal routing is used to dynamically route around faults in a network. However, non-minimal routing causes network interference between processes in different physical partitions. In addition, non-minimal routing permits livelock situations to occur, because forward progress is not guaranteed. Deadlock avoidance becomes more complicated with non-minimal routing.

As is known, deadlock is a significant issue in the construction and design of multi-node networks. Both partially-adaptive and fully-adaptive algorithms have been implemented to avoid deadlock. Issues such as latency and network congestion are also significant issues for the design and construction of multi-node networks.

Nothwithstanding the evolution of routing methodologies summarized above, further improvements are still desired.

### SUMMARY

A system and method are provided for routing information in a multi-node network. In one embodiment of a multi-node network comprising a plurality of distributed switching nodes, a method is implemented in at least one of the plurality of nodes for routing information entering the node over a first channel to one of a plurality of other channels. The method comprises obtaining priority information for the information, ascertaining a remaining communication length for the information for each of the plurality of other channels, determining a current demand for each of the plurality of other channels; and routing the information entering at the first channel to one of the other channels based upon an evaluation that considers a combination of the obtained priority information, the ascertained communication length for each of the plurality of other channels, and the current demand for each of the plurality of other channels.

### DESCRIPTION OF THE DRAWINGS

The accompanying drawings incorporated in and forming a part of the specification, illustrate several aspects of the present invention, and together with the description serve to explain the principles of the invention. In the drawings:

FIGS. 1A and 1B are diagrams illustrating known nodal network topologies.

FIG. 2 is a diagram illustrating certain functional components in a node of a nodal network architecture constructed in accordance with one embodiment of the invention.

FIG. 3 is a block diagram illustrating certain functional components that comprise routing logic of an embodiment of the invention.

FIG. 4 is a diagram similar to FIG. 2, illustrating certain functional components of a node of an embodiment of the invention.

FIG. 5 is a diagram similar to FIG. 3 illustrating certain functional components that comprise routing logic of an embodiment of the invention.

FIGS. 6 and 7 are flowcharts illustrating the top-level functional operation of embodiments of the invention.

### DETAILED DESCRIPTION OF THE PREFERRED EMBODIMENTS

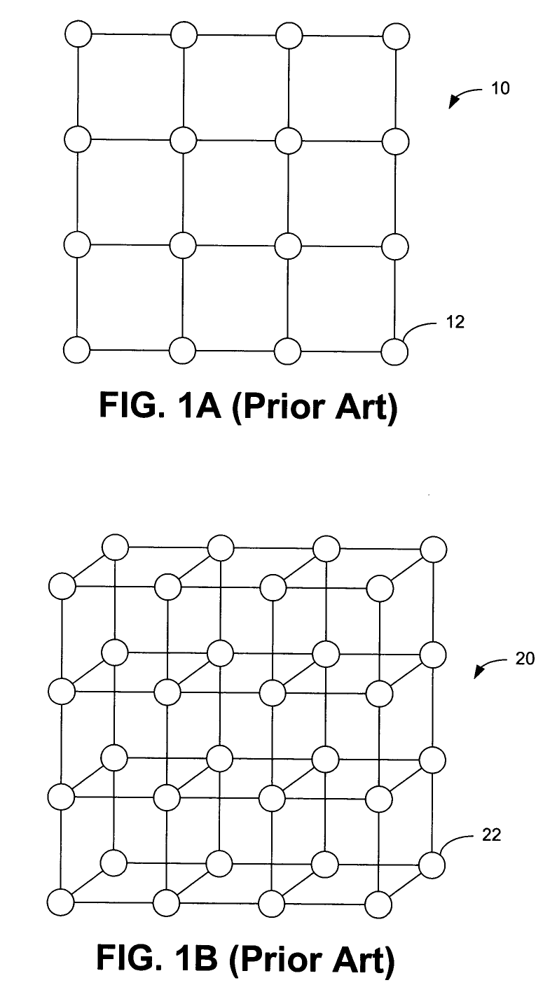

Reference is made to FIGS. 1A and 1B, which illustrate known network topologies, depicting exemplary operating environments of the present invention. FIG. 1A illustrates a multi-node mesh-network topology 10 having a plurality of nodes 12 that are configured in a two-dimensional arrangement, with interconnecting channels for communicating information among the various nodes. In such a network topology, nodes 12 may be addressed using an X,Y coordinate identification system. In this way, when a destination address (i.e., X,Y coordinate values) is known, a current node, possessing information to be communicated to a destination node, can make routing decisions based upon the destination address. Likewise, FIG. 1B illustrates a multi-node, three-dimensional network topology. In such a topology, addressing may be performed using X,Y, Z coordinate values. In this regard, if a current node is addressed by coordinates 2, 4, 2, and a destination node address is 4, 4, 2, it is readily ascertained that the message need only traverse two additional nodes to reach its destination.

In other network configurations, where a separation or location cannot be readily ascertained from the address alone, a priori information about the network topology may be required by a given node in order to effectively perform routing operations for communicating information to a destination node. This a priori knowledge may be provided at a time of initial configuration of the network, or alternatively may be developed over time through periodic network communications.

It should be appreciated that the network topologies illustrated in FIGS. 1A and 1B are provided purely for purposes of illustration and are not to be construed as limiting upon the operating environment of the present invention. Indeed, as will be appreciated from the description herein, the present invention is applicable to a wide variety of network topologies. Further, network communications, addressing mechanisms and methodologies, state maintenance, intranetwork communications, and other mechanisms and implementation details are known, and therefore persons skilled in the art will understand the utilization of such mechanisms and methodologies in the implementation of the concept and features of the present invention described herein.

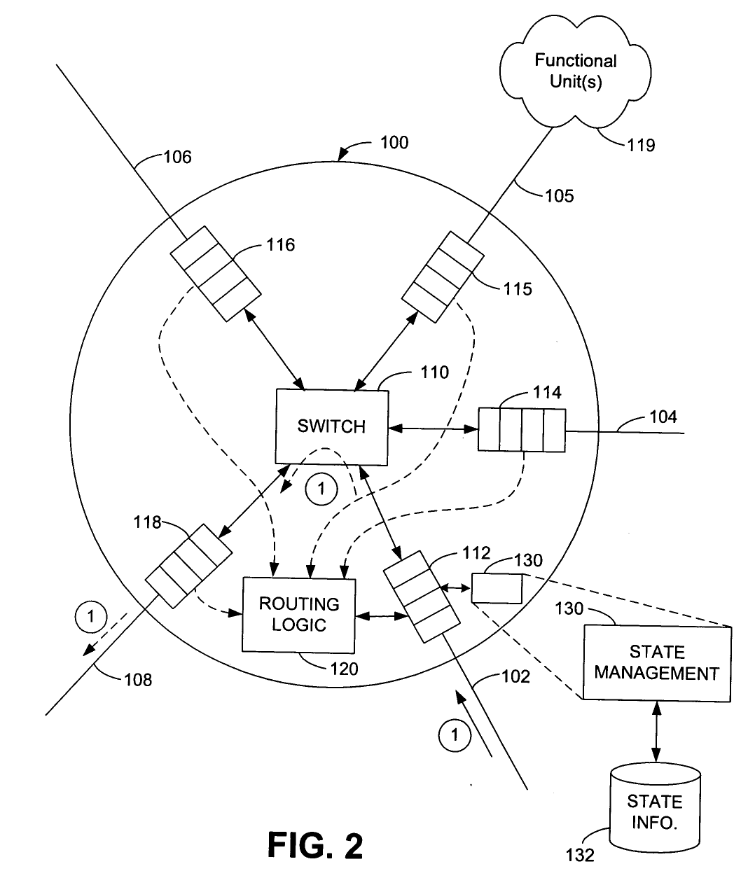

Reference is now made to FIG. 2, which illustrates a node 100 that may be utilized in a multi-node network constructed in accordance with one embodiment of the present invention. In the illustrated embodiment, the node 100 includes five channels 102, 104, 105, 106, and 108 for communicating with other nodes in the system. In the illustrated embodiment, it will be assumed that the channels are bidirectional. However, consistent with the invention, the communication channels could be uni-directional. Further, as is used herein, the term “channel” may apply to physical, logical, or virtual channels. FIG. 2 specifically illustrates the routing of an incoming message 1 on communication channel 102 to output the message on channel 108. It will be appreciated that, at any given instant in time, various messages or information may be arriving and/or departing the node 100 over the various communication channels 102, 104, 105, 106, and 108. For simplicity, however, only a single message or information packet 1 has been illustrated. As used herein, a message may include a definable communication packet, flit, or a collection of related flits.

With regard to message and information routing, the node 100 includes a switch 110, which is configured to switch and route messages among the various communication channels. Switches of this type are well-known, and therefore details of its structure and operation will be understood by persons skilled in the art. Various input and output message queues 112, 114, 115, 116, and 118 are illustrated and serve to buffer both incoming and outgoing messages on the various communication channels.

Generally, each node in a multi-node network will have one or more functional units 119 associated with a node, and in communication with the node via one or more communication channels. If, for example, the incoming message 1 was destined for the node 100 (e.g., information to be utilized by a functional unit 119 associated with the node 100), then the message 1 would be routed through the switch 110 to the functional unit 119 over communication channel 105.

As summarized above, the present invention generally relates to the adaptive routing of messages at a node 100 in a multi-node network architecture. In continuing with the illustration of FIG. 2, for an incoming message 1 that arrives at the node 100 on channel 102, the message 1 will be routed to one of the four other communication channels 104, 105, 106, or 108. In this regard, it is understood that the message 1 would not enter the node 100 on communication channel 102 only to be communicated out of the node 100 across the same channel. There are various factors, which will be discussed below, that determine which other channel the message 1 is to be directed to. These factors are evaluated by routing logic 120, which is associated (in the embodiment of FIG. 2) with an input of the communication channel 102. As will be discussed in more detail below, factors that are utilized by the routing logic 120 include the priority of the incoming message, the communication length between the current node 100 and the ultimate destination for the incoming message 1, the current utilization or demand by the various other channels 104, 105, 106, and 108 of the node 100, as well as other factors. In making the routing determination, the routing logic 120 receives communication input from the various other communication channels of the node 100.

Also illustrated in FIG. 2 is a logic block denoted as “state management” 130. This block denotes logic for managing, maintaining, and communicating state information of a given communication channel. As further illustrated, the state management logic 130 includes or communicates with a database or memory segment containing state information 132. The specific state information may vary from embodiment to embodiment, but generally includes information such as the current activity on the associated communication channel, the current utilization of input and output queues, etc. The state information may further include information about the congestion and/or channel utilization of channels intercommunicating between remote nodes in the system, as this information can be used to factor into the determination as to the direction a current packet may be dispatched (e.g., to route a current package in a direction away from a congested area).

It should be further appreciated that routing logic 120 and state management logic 130 may be associated with each communication channel of the node 100. However, for simplicity of illustration, only those components illustrated with the communication channel 102 have been illustrated herein. It should be further appreciated that the information communicated to the routing logic 120 from the various other communication channels 104, 105, 106, and 108 may include state information associated with the various respective channels.

Consistent with the scope and spirit of the present invention, a variety of algorithms may be utilized by the routing logic 120. As described herein, the principal factors utilized by the routing logic 120 include priority information, communication length, and demand information for each of the communication channels of the node 100.

Additional factors include network traffic in remote areas of the network. However, the weighting of these various factors within the routing logic 120 may vary from embodiment to embodiment.

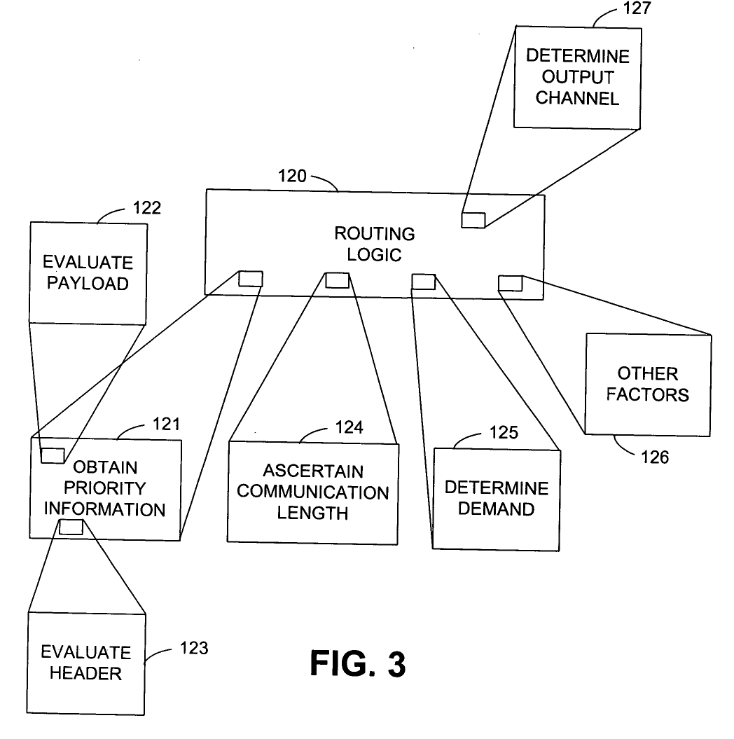

Reference is now made to FIG. 3, which is a diagram illustrating certain functional portions of the routing logic 120. With regard to the priority information associated with a given message, the priority is a general indicator related to the urgency of the message, or the need to reach the destination in a timely fashion. Consider, for example, a communication network. Data being communicated in, for example, a file transfer operation may have a lower priority than data or information being communicated in connection with audio, video, or other streaming data that is to be communicated or handled in real time. Logic is included within the routing logic 120 for obtaining the priority information associated with a given message. In one embodiment, the logic 121 may obtain the priority information from a header portion associated with the message or information packet. Logic 123 may be provided for performing this function. In an alternative embodiment, logic 122 may be provided for evaluating the payload of a message to make a determination as to the priority of the message or information being communicated.

The routing logic 120 also includes logic 124 for ascertaining the communication length. In this regard, the communication length generally refers to a number of nodes which the current message must traverse before reaching the destination node. As mentioned above, this determination may be made based upon a priori information about the network or the network topology. Depending upon the topology, this information may be known at the time the network is constructed, or may be developed over time through on-going intranetwork communications with other nodes, which communications convey relational network information. In the preferred embodiment, the routing logic 120 ascertains the outgoing communication channel for an incoming message for each of the other channels 104, 105, 106, and 108 that the message may be directed to.

The routing logic 120 also includes logic 125 for determining a current demand associated with each of the other communication channels. In a preferred embodiment, this logic operates by evaluating state information associated with each of the other channels and/or evaluating the amount of information presently stored in output queues for communication over the other channels. Additional logic 126 may also be provided within the routing logic for utilizing in the routing determination. Finally, logic 127 is provided for determining the output channel in which to route the incoming message. As mentioned above, this logic may vary from embodiment to embodiment. In one embodiment, it may determine an output channel based upon a substantially equal or balanced weighting among the various factors, including priority information, communication length, and demand. In other embodiments, however, these factors may be disproportionately weighted. Indeed, one or more of these factors may be discounted or ignored completely.

In returning to the illustration of FIG. 2, it will be appreciated that details regarding the state and queue management associated with each of the communication channels, virtual channel allocation and control, intranode control and signaling, and other environmental and implementation details will be generally understood by persons skilled in the art, and therefore need not be specifically illustrated or described herein.

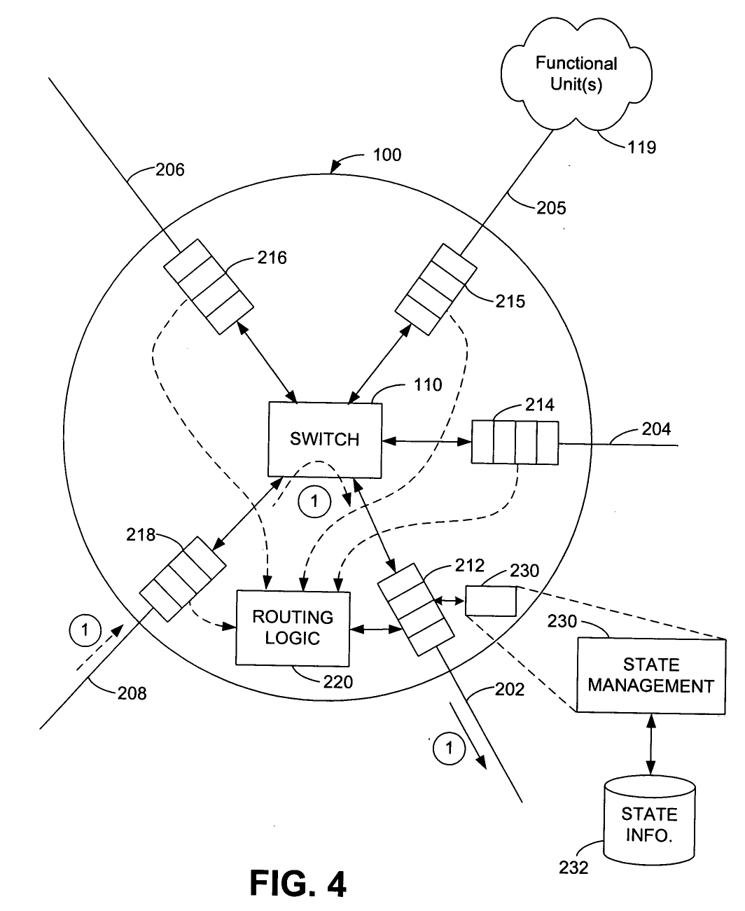

Reference is now made to FIG. 4, which is an illustration similar to FIG. 2, but illustrates an alternative embodiment and implementation of the present invention. Generally, the structural components are similar in structure and operation, and therefore like reference numerals have been used to designate these components. In the embodiment of FIG. 4, the node 100 includes five communication channels 202, 204, 205, 206, and 208. Communication queues 212, 214, 215, 216, and 218 are associated with the respective communication channels. Like the embodiment of FIG. 2, the node 100 of FIG. 4 includes routing logic 220, state management 230, and state information 232. In the embodiment of FIG. 2, the routing logic 120 was configured to monitor incoming communications at a given communication channel and determine which other communication to route that message to. In FIG. 4, routing logic 200 monitors the outgoing communications of a given communication channel 202, and based, in part, upon that information determines, from one of the other communication channels 204, 205, 206, and 208, where to route the next incoming message from. At any given instant in time, incoming messages may be present on a plurality of the other channels. Based generally upon the priority, communication length, and demand factors discussed above, the routing logic 220 determines which, if any, of those messages to route so as to output over communication channel 202.

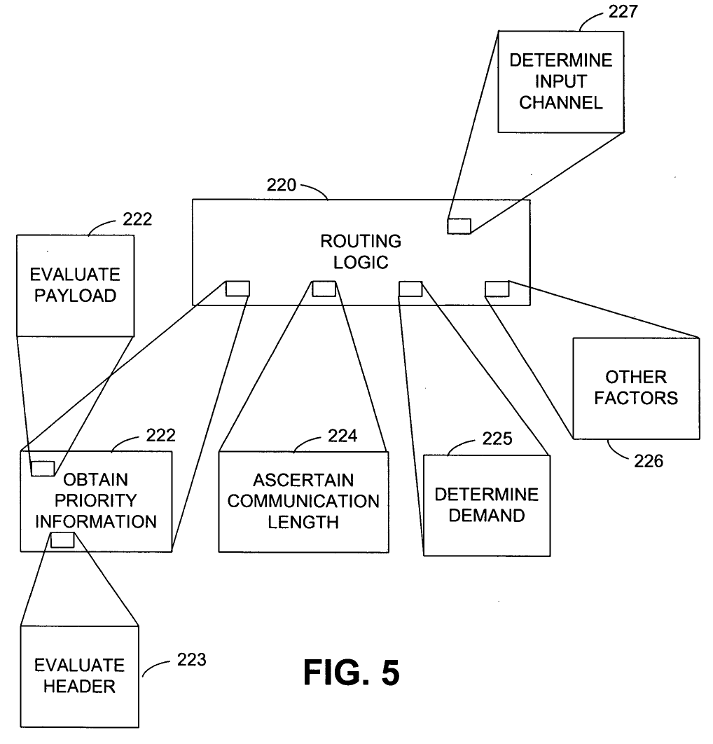

With reference to FIG. 5, the routing logic 220 includes logic 221 for obtaining priority information. Like the embodiment of FIG. 3, this priority information may be obtained from logic 222 configured to evaluate the payload of an information packet, or from logic 223 configured to evaluate a header portion of the information packet. Specifically, the priority information is obtained from the incoming information on each of the other communication channels 204, 205, 206, and 208. Logic 224 is also provided for ascertaining a communication length associated with incoming messages on each of the other communication channels. That is, the communication length of each message is computed as if the message were to be routed out of the node 100 over communication channel 202.

Routing logic 220 also includes logic 225 for determining the demand of the present communication channel 202. This determination of demand may be made by evaluating the state information 232. As discussed above in connection with the embodiment illustrated in FIG. 2, the routing logic 220 may also evaluate the channel usage or congestion of remote channels, and this information may be maintained and updated as a part of the state information. As further described below, one way of ascertaining or updating this information may be for each node to periodically broadcast (using underutilized channels) demand and utilization information about its local channels. This information would then disburse throughout the nodes in the network. Alternatively, nodes could dispatch messages/requests to specific nodes of interest, to inquire as to the network traffic surrounding that node. Further still, a combination of the two approaches may be used. Thus, for example, if periodic broadcasting, from one or more nodes, information about the network traffic local to those nodes did not sufficiently propagate throughout the network, this information could be specifically queried by nodes desiring the information. Preferably, information communicating this network utilization and traffic information is communicated over underutilized channel, so that it does not (itself) create congestion problems. Further, unbuffered message classes can be a particularly useful means to communicate through stalled channels to alleviate congestion, and could be utilized in this context.

In an alternative embodiment, the routing logic 220 may perform its evaluation based, in part, upon state information obtained from the other communication channels. In this regard, the routing logic 220 may receive information that includes the respective demands, communication channels, etc., from the various other communication channels. Of course, if the routing logic 220 makes a determination to route an incoming communication message from one of the other communication channels to output over channel 202, it will preferably communicate that determination to counterpart routing logic (not shown) associated with the various other communication channels.

As mentioned in connection with FIG. 3, the routing logic 220 may also include logic 226 for determining other factors and logic 227 for determining the input channel from which to route a current message.

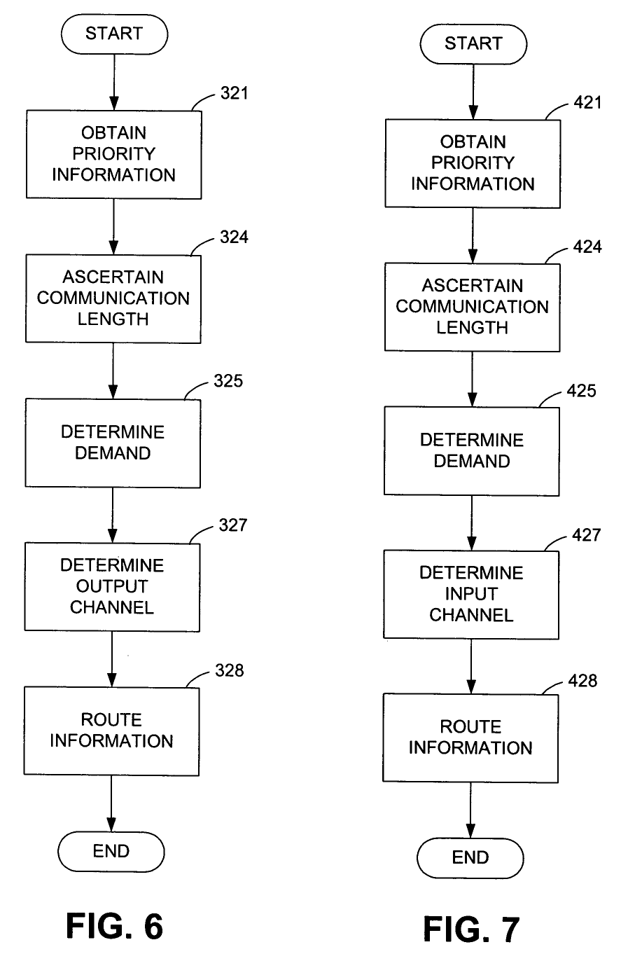

Reference is now made to FIG. 6, which is a flowchart illustrating the top-level functional operation of a method constructed in accordance with the embodiment illustrated in FIGS. 2 and 3. In accordance with one method, for a given input channel, the method obtains priority information for incoming message (step 321). It also ascertains a communication length associated with various message for each of the various other communication channels (step 324). The method also determines a demand of the various output channels (step 325). It should be appreciated that these steps may be performed in the order listed, performed in an alternative order, or performed concurrently, consistent with the scope and spirit of the invention. Thereafter, a determination is made as to which of the other communication channels and incoming message should be routed to (step 327). Finally, the method routes the information (step 328) to the determined output channel.

Reference is now made to FIG. 7, which is a flowchart illustrating the top-level operation of a system constructed in accordance with the embodiment of FIGS. 4 and 5. For a given output channel, the method obtains priority information for incoming messages on the various other communication channels (step 421). It also ascertains a communication length associated with various incoming messages on the other communication channels (step 424). The method also determines a demand of the output channel associated with the routing logic (step 425). It should be appreciated that these steps may be performed in the order listed, performed in an alternative order, or performed concurrently, consistent with the scope and spirit of the invention. Thereafter, the method determines an input channel from which to route an incoming message (step 427), and then routes that information to the current output channel (step 428).

In accordance with another embodiment of the present invention, the routing logic may implement a more sophisticated determination of demand (or channel utilization), such that the utilization of downstream channels (e.g., communication channels that are not directly coupled to the current node) are considered and factored into the routing determination. By way of illustration, assume that a packet is to be routed from a current node to a destination node, and there are two possible channels leaving the current node. If a first channel leads to a node having highly congested channels, while the second channel leads to a node having underutilized outgoing channels, then (assuming all other factors are equivalent) it is desirable to route the packet to the second node. Of course, further downstream information may also be factored into the determination.

In order to implement such an approach, each node preferably maintains information about the relative channel usage or congestion throughout the system. There are various ways that this may be achieved. One way would be to have each node execute a monitoring task that keeps a constant assessment of the utilization or traffic on all channels that are directly coupled to it. It could them dispatch this information through information packets destined to other nodes throughout the system. Preferably, such packets would be communicated with a low priority, and therefore be communicated across underutilized channels, so that they do not themselves create a congestion problem. Upon receipt of such an information packet from another node, a current node could update its state information (e.g. 132 of FIG. 2 or 232 of FIG. 4) of other nodes or remote communication channels. This information could then be utilized by the routing logic in making routing determinations.

1. In a multi-node network comprising a plurality of distributed switching nodes, a method implemented in at least one of the plurality of nodes for routing information entering the node over a first channel to one of a plurality of other channels, the method comprising:
obtaining priority information for the information;
ascertaining a remaining communication length for the information for each of the plurality of other channels;
determining a current demand for each of the plurality of other channels; and
routing the information entering at the first channel to one of the other channels based upon an evaluation that considers a combination of the obtained priority information, the ascertained communication length for each of the plurality of other channels, and the current demand for each of the plurality of other channels.

2. The method of claim 1 further comprising determining a demand for channels coupled to remote nodes between a current node and a destination node and utilizing this information in determining a channel over which to route the information

3. The method of claim 1 further comprising obtaining a destination node from a header portion of the information.

4. The method of claim 1, wherein ascertaining a remaining communication length more specifically comprises ascertaining a quantifiable identification of a number of intermediate nodes that the information will traverse before reaching a destination node.

5. The method of claim 1, wherein the obtaining priority information more specifically comprises retrieving a priority indicator from a header portion of the information.

6. The method of claim 1, wherein the obtaining priority information more specifically comprises evaluating a payload portion of the information.

7. The method of claim 1, wherein the ascertaining the remaining communication length comprises receiving and evaluating information communicated from other nodes in the network.

8. The method of claim 1, wherein the ascertaining the remaining communication length comprises computing the communication length based on a priori information about the network.

9. The method of claim 1, wherein the determining the current demand for each of the plurality of other channels comprises evaluating a state of an output queue for each of the other channels.

10. The method of claim 1, wherein the routing the information comprises a substantially balanced weighting of the obtained priority information, the ascertained communication length, and the current demand.

11. The method of claim 1, wherein the routing the information comprises an unbalanced weighting of the obtained priority information, the ascertained communication length, and the current demand.

12. The method of claim 1, wherein the information is embodied in a packet.

13. The method of claim 1, wherein the information is embodied in a flit.

14. The method of claim 1, wherein the information is embodied in a plurality of flits that collectively comprise an information packet.

15. The method of claim 14, wherein the routing is performed on a per-flit basis.

16. The method of claim 14, wherein the routing is performed on a first flit, and remaining flits in information packet are routed to the same other channel as the first flit.

17. In a multi-node network comprising a plurality of distributed switching nodes, a method implemented in at least one of the plurality of nodes for routing information out of the node over a first channel from one of a plurality of other channels, the method comprising:
obtaining priority information for information entering the node for each of the plurality of other channels;
ascertaining a remaining communication length for a information entering the node for each of the plurality of other channels;
determining a current demand the first channel; and
routing the information entering at one of the other channels to the first channel based upon an evaluation that considers a combination of the obtained priority information for each of the plurality of other channels, the ascertained communication length for each of the plurality of other channels, and the current demand for the first channel.

18. The method of claim 17, further comprising determining a demand for channels coupled to remote nodes between a current node and a destination node and utilizing this information in determining a channel over which to route the information

19. The method of claim 17, wherein the routing the information comprises a substantially balanced weighting of the obtained priority information, the ascertained communication length, and the current demand.

20. The method of claim 17, wherein the routing the information comprises an unbalanced weighting of the obtained priority information, the ascertained communication length, and the current demand.

21. A node for routing information entering the node over a first channel to one of a plurality of other channels in a multi-node network comprising a plurality of distributed switching nodes, the node comprising:
logic configured to obtain priority information for the information;
logic configured to ascertain a remaining communication length for the information for each of the plurality of other channels;
logic configured to determine a current demand for each of the plurality of other channels; and
logic configured to route the information entering at the first channel to one of the other channels based upon an evaluation that considers a combination of the obtained priority information, the ascertained communication length for each of the plurality of other channels, and the current demand for each of the plurality of other channels.

22. The method of claim 1, wherein the logic configured to route the information is configured to route the information based upon a substantially balanced weighting of the obtained priority, the ascertained communication length, and the current demand.
